(19) United States
(12) Patent Application Publication
(10) Pub. No.: US 2007/0279322 A1
(43) Pub. Date: Dec. 6, 2007

(54) NUMERIC DISPLAY

(75) Inventors: David Good, Irving, TX (US); Arnon Z. Wilson, Frisco, TX (US); Joe Wilson, Plano, TX (US)

Correspondence Address: HITT GAINES P.C., P.O. BOX 832570, RICHARDSON, TX, 75083, US

(73) Assignee: FutureMedia Displays, Inc., Carrollton, TX (US)

(21) Appl. No.: 11/757,236

(22) Filed: Jun. 1, 2007

Related U.S. Application Data
(60) Provisional application No. 60/803,810, filed on Jun. 2, 2006.

(51) Int. Cl. G09G 3/14

(52) U.S. Cl. 345/46

(57) ABSTRACT

A numeric display, comprising a matrix having nominally m columns by n rows, a plurality of light emitting diodes populating at least some of the matrix, first and second void areas within the matrix wherein respective first and second subsets of the m columns by the n rows are devoid of light emitting diodes, and a controller coupled to the plurality of light emitting diodes and configured to select a one of a plurality of fonts. The controller is further configured to energize a third variable subset of the m columns by the n rows for at least one of a set of cardinal numerals, wherein the third variable subset is chosen from the one of the plurality of fonts.

### CROSS-REFERENCE TO PROVISIONAL APPLICATION

This application claims the benefit of U.S. Provisional Application No. 60/803,810 entitled “DISPLAY SIGN” to Good, et al., filed on Jun. 2, 2006 which is commonly assigned with the present invention and incorporated herein by reference as if reproduced herein in its entirety.

### TECHNICAL FIELD OF THE INVENTION

The present invention is directed, in general, to signage and, more particularly, to a matrix illuminated display sign with selectable font.

### BACKGROUND OF THE INVENTION

Neon tubes, liquid crystal displays (LCDs) and light emitting diodes (LEDs) have been successfully used for many years as display signage for drawing a potential customer's attention to merchandise, facilities, prices, etc. Neon tubes have the unfortunate drawback of lacking flexibility of display once formed; although they provide excellent attention gathering for such merchandise as liquid beverages, manufacturer's logos, etc., that do not change shape or value. LCDs have some flexibility to display alphanumeric characters depending upon the shape chosen for the individual LCDs, however they do not necessarily have sufficient brightness for daylight display. LEDs, on the other hand, have sufficient brightness and lend themselves conveniently to full matrix displays whereby alphanumerics of any complexity may readily be achieved providing the number of horizontal and vertical LED rows is sufficient in number to fully populate each character field. Total flexibility to display all alphanumerics in a variety of fonts necessarily requires a fully populated field of LEDs for each character to be displayed and depending upon the complexity of the font may require a very dense population of LEDs. While fully populated fields for all characters makes for simplicity of manufacturing, it is wasteful if some of the elements are not to be used in a particular application. That is, some applications need to display changing characters but are dedicated to a particular type of display and do not require a fully populated field for each character. For example, gasoline pricing signs need only display numeric characters wherein some areas of the field may never be required. However, some gasoline distributors are very specific about what font is used for their displays, thereby placing manufacturing cost in competition with marketability.

Accordingly, what is needed in the art is a display system that is tailored to specific needs of a particular application, yet provides flexibility to change fonts to suit a client's needs.

### SUMMARY OF THE INVENTION

To address the above-discussed deficiencies of the prior art, the present invention provides a numeric display, comprising a matrix having nominally m columns by n rows, a plurality of light emitting diodes populating at least some of the matrix, first and second void areas within the matrix wherein respective first and second subsets of the m columns by the n rows are devoid of light emitting diodes, and a controller coupled to the plurality of light emitting diodes and configured to select a one of a plurality of fonts. The controller is further configured to energize a third variable subset of the m columns by the n rows for at least one of a set of cardinal numerals, wherein the third variable subset is chosen from the one of the plurality of fonts.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates an elevation view of a numeric matrix display constructed according to the principles of the present invention;

FIG. 2 illustrates a plan view of the controller of FIG. 1;

FIGS. 3A through 3D illustrate the numeric matrix display of FIG. 1 with a single numeral nine (9) in four different exemplary fonts;

FIG. 4 illustrates multiple numeric matrix displays of FIG. 1 as they would be arranged to display a price of a unitary item; and

FIG. 5 illustrates multiple numeric matrix displays of FIG. 1 as they would be arranged to display a price of gasoline in the USA.

### DETAILED DESCRIPTION

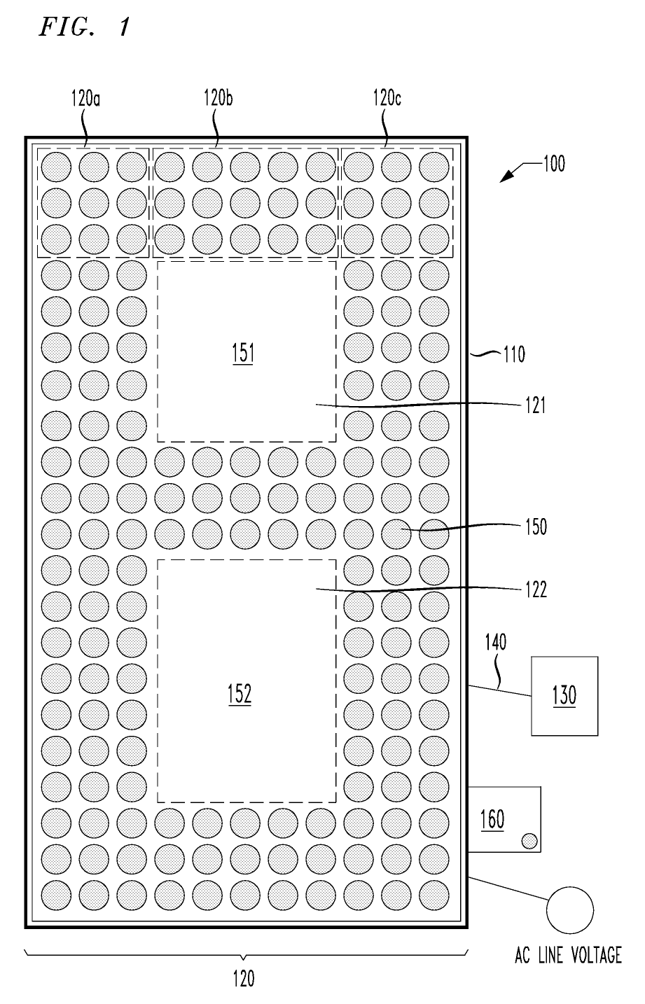

Referring initially to FIG. 1, illustrated is an elevation view of a numeric matrix display 100 constructed according to the principles of the present invention. The numeric matrix display comprises a frame 110, a matrix 120, a controller 130, and a communication link 140. In one embodiment, the matrix 120 comprises m columns by n rows. The matrix 120 may comprise a plurality of sub-matrices 120a-120n. In the illustrated example, each of the sub-matrices 120a-120n comprises an array of p columns by p rows where p=>3, although the number of columns does not necessarily have to equal the number of rows. In a preferred embodiment, a plurality of light emitting diodes (LEDs) 150 populates at least some of the matrix 120 wherein the LEDs 150 comprise sunlight-viewable LEDs 150 having an adjustable brightness to compensate for varying ambient light conditions. That is, the minimum brightness is automatically adjusted for readability under changing ambient light conditions such as: sunrise, sunset, haze, fog, etc. In another embodiment, the matrix display 100 further comprises an automatic proportional brightness control 160 for controlling the brightness of the LEDs. In a preferred embodiment, the LEDs are continuously illuminated.

In a preferred embodiment, the matrix display 100 is customized to display Hindu-Arabic numerals (also called Hindu numerals, Arabic numerals or Indian numerals) zero (0) through nine (9) The matrix 120 further comprises first and second void areas 121, 122 wherein respective first and second subsets 151, 152 of the m columns by n rows are devoid of LEDs as these areas are not needed for display of Hindu-Arabic numerals in the fonts named below.

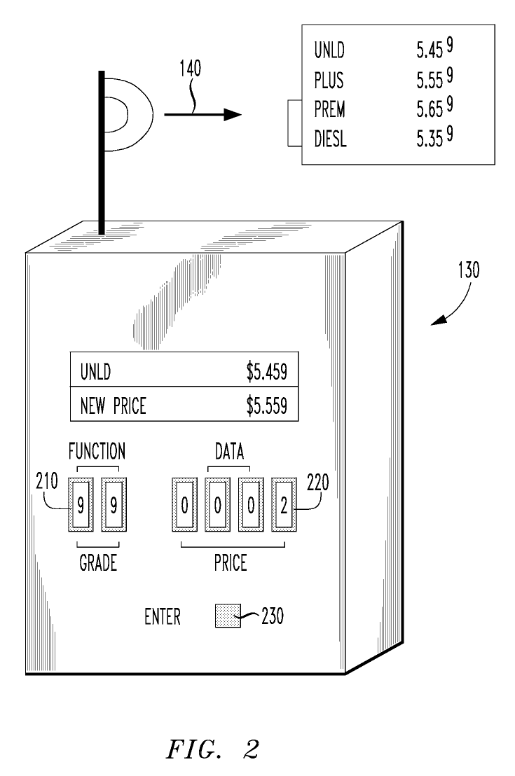

Referring now to FIG. 2, illustrated is a plan view of the controller 130 of FIG. 1. In one embodiment, the controller 130 comprises a plurality of selectable fonts for display of the numerals zero through nine on the display matrix 120. For example, the plurality of selectable fonts may include: Courier/Courier New, Times New Roman, Arial, Georgia, Lucida Bright, Lucida Sans, etc. One who is of skill in the art will recognize that other fonts may also be used. To enable a given font, a numeric code, e.g., 99, is entered with thumb wheels 210 to select Font Selection Mode. Thumb wheels 220 are used to set discrete numerals representing a specific code associated with a specific font, e.g., 0001 and Courier, 0002 and Times New Roman, 0003 and Arial, etc. The font is then selected by pressing Enter button 230. Usually, the font need only be selected once by the original owner, and will therefore remain unchanged. However, should the retail store change ownership, the new owner or brand change may desire to change the font, which can then be done as described above.

In one embodiment, the communication link 140 couples the controller 130 to the LEDs 150 of the matrix 120 by conventional wire. In an alternative embodiment, the communication link 140 couples the controller 130 to the LEDs 150 of the matrix 120 by wireless radio frequency transmitter. One who is of skill in the art will readily understand how these embodiments are implemented.

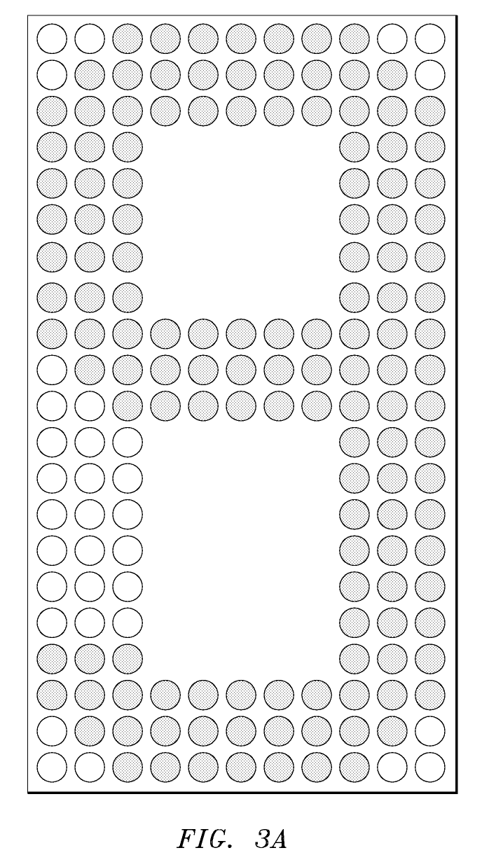

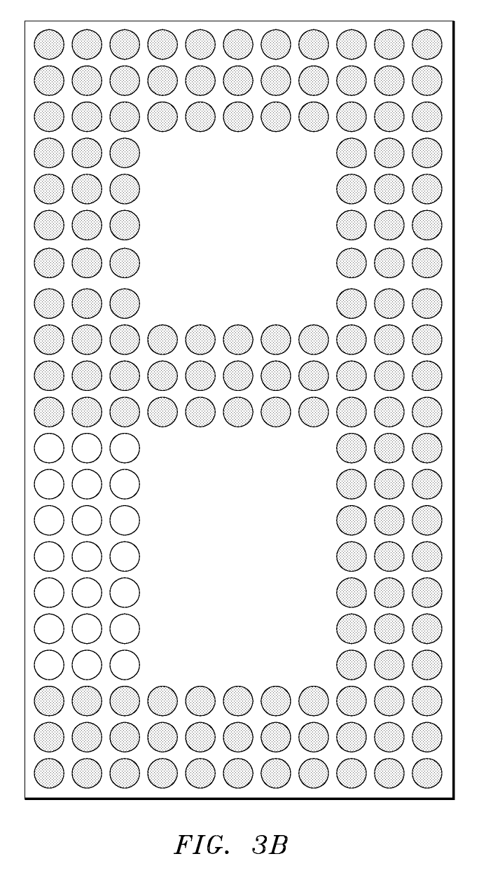

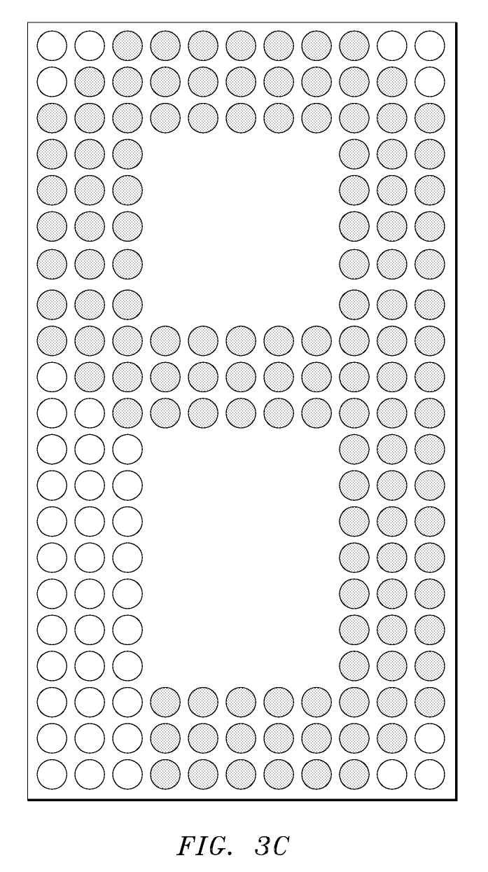

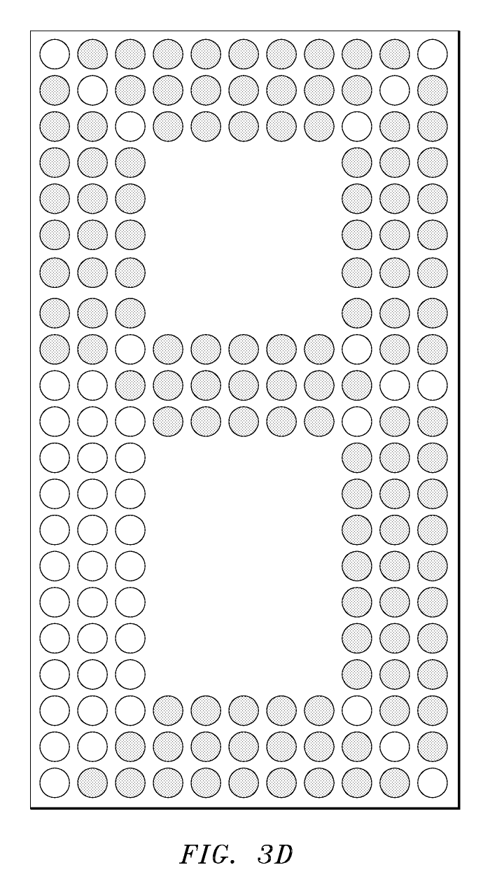

Referring now to FIGS. 3A-3D, illustrated is the numeric matrix display 100 of FIG. 1 with a single numeral nine (9) in four different exemplary fonts. The fonts shown are for illustrative purposes only to show the flexibility of the display and do not necessarily represent any of the fonts previously mentioned. In one embodiment, the LEDs are arranged in a plurality of rows and arranged as in FIG. 2 with each display capable of displaying any single cardinal numeral from zero through nine in a given font. In a preferred embodiment, the plurality of rows may vary from three rows to nine rows or more. The fonts will be rendered better when more rows and columns of LEDs are used. The numeric characters are displayed as a third variable subset of the m columns by n rows when mapped by the selected number into the selected font onto the matrix 120. In a further embodiment, the LEDs may be offered in a variety of colors, e.g., red, green, blue, white, etc. In one embodiment, the color of the LEDs may be selected to conform to local convention. For example, automotive gasoline in the US is often offered for sale with the prices displayed in red and the diesel fuel price is often displayed in green.

In one embodiment, the LEDs may flash to catch a potential customer's attention. The LEDs may also be driven selectively to full brightness, made to scroll, or “wave” the numerals in brightness. Alternatively, the LEDS may change brightness, form in a shrinking manner or visually explode for the same purpose. One who is of skill in the art will understand the variety of eye-catching approaches that may be used.

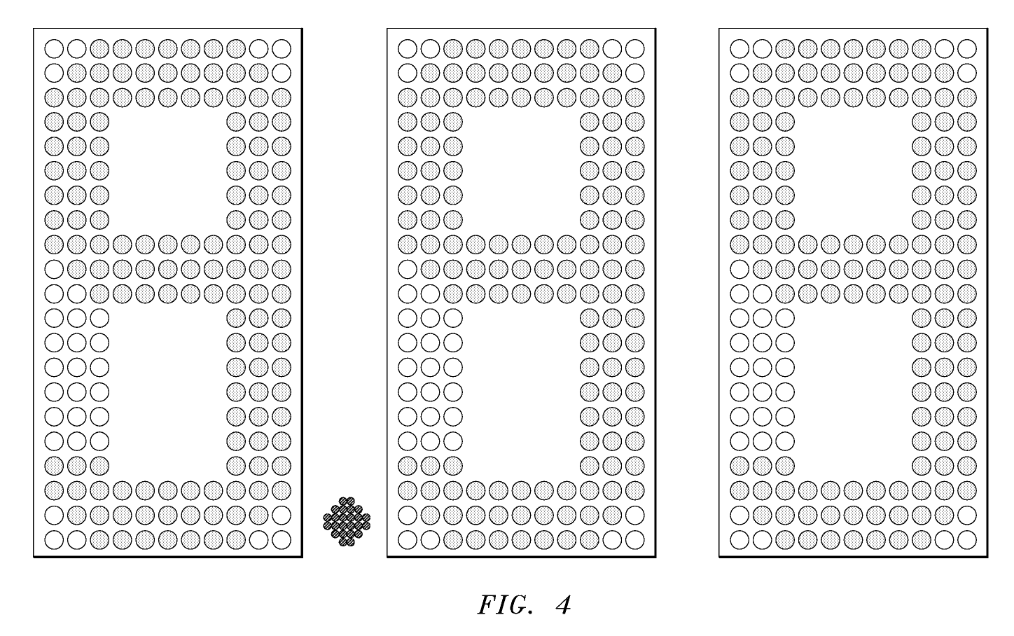

Referring now to FIG. 4, illustrated are multiple numeric matrix displays 100 of FIG. 1 as they would be arranged to display a price of a unitary item. In a preferred embodiment, multiple matrix displays 100 are arranged to reflect local pricing convention, i.e., in the US for unitary pricing, the convention is dollars and cents separated by a decimal point, e.g., 2.87 with or without a preceding dollar sign. The decimal point is represented again with a matrix of LEDs. This convention is suitable for items sold as a unit, such as: a quart of milk, a pack of cigarettes, a six-pack of beer, etc.

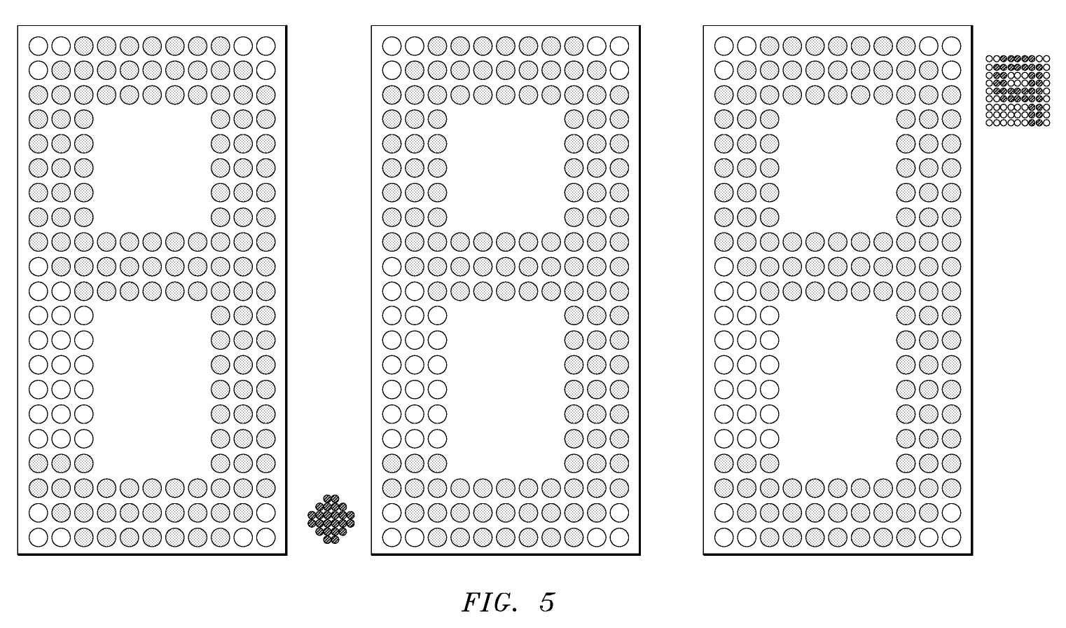

Referring now to FIG. 5, illustrated are multiple numeric matrix displays 100 of FIG. 1 as they would be arranged to display a price of gasoline in the USA. In a preferred embodiment, for the US sale of gasoline by the gallon, the convention is dollars and cents separated by a decimal point, usually without the dollar sign, and with the usual addition of 9/10 cent, or a numeral 9 smaller than the main price and raised to the top of the sign as in a superscript, e.g., 2.89⁹ or 2.89^{9/10}. On the actual display, the top of the 9 or 9/10 is often level with the dollar and cents numerals. Alternatively, the 9/10 may be located vertically as in: 9/10. The tenths matrix is again populated with LEDs necessary to form the characters. Depending upon the density of the LED matrix, some locations of the tenths matrix may also be void if available fonts permit.

Thus, a numeric display sign has been described having a capability to changeably display cardinal numerals from zero (0) through nine (9) in a plurality of fonts.

The term “providing”, as used herein, means that the feature/element may be obtained from a party having already manufactured the feature/element, or alternatively may mean manufacturing the feature/element themselves and providing it for its intended purpose.

Although the present invention has been described in detail, those skilled in the pertinent art should understand that they can make various changes, substitutions and alterations herein without departing from the spirit and scope of the invention in its broadest form.

What is claimed is:

1. A numeric display, comprising:
a matrix having nominally m columns by n rows;
a plurality of light emitting diodes populating at least some of said matrix;
first and second void areas within said matrix wherein respective first and second subsets of said m columns by said n rows are devoid of said plurality of light emitting diodes; and
a controller coupled to said plurality of light emitting diodes and configured to select a one of a plurality of fonts, said controller further configured to energize a third variable subset of said m columns by said n rows for at least one of a set of cardinal numerals, said third variable subset chosen from said one of said plurality of fonts.

2. The numeric display as recited in claim 1 wherein said plurality of fonts includes at least a plurality of: Courier, Times New Roman, Lucida, Lucida Sans, Arial, or Georgia.

3. The numeric display as recited in claim 1 wherein said controller is coupled by wiring to said plurality of light emitting diodes.

4. The numeric display as recited in claim 1 wherein said controller is wirelessly coupled to said plurality of light emitting diodes.

5. The numeric display as recited in claim 1 wherein said controller further comprises a thumb wheel input device.

6. The numeric display as recited in claim 5 wherein said input device is configured to select discrete numerals.

7. The numeric display as recited in claim 1 wherein said cardinal numerals comprise digits from zero through nine.

8. The numeric display as recited in claim 1 wherein said cardinal numerals comprise Hindu-Arabic digits from zero through nine.

9. The numeric display as recited in claim 1 wherein said numeric display is a price display sign.

10. The numeric display as recited in claim 1 wherein said third variable subset of said plurality of light emitting diodes is continuously illuminated.

11. The numeric display as recited in claim 1 wherein a level of brightness of said plurality of light emitting diodes is adjustable for changing ambient light.

12. The numeric display as recited in claim 11 wherein said level of brightness of said plurality of light emitting diodes is automatically adjusted for changing ambient light.

13. A method of manufacturing a display sign, comprising:
providing a matrix having nominally m columns by n rows;
populating at least some of said matrix with a plurality of light emitting diodes;
forming first and second void areas within said matrix wherein respective first and second subsets of said m columns by said n rows are devoid of said plurality of light emitting diodes; and
coupling a controller to said plurality of light emitting diodes and configuring said controller to select a one of a plurality of fonts, and further configuring said controller to energize a third variable subset of said m columns by said n rows for at least one of a set of cardinal numerals, said third variable subset chosen from said one of said plurality of fonts.

14. The method as recited in claim 13 wherein said plurality of fonts includes at least a plurality of: Courier, Times New Roman, Lucida, Lucida Sans, Arial, or Georgia.

15. The method as recited in claim 13 wherein said controller is coupled by wiring to said plurality of light emitting diodes.

16. The method as recited in claim 13 wherein said controller is wirelessly coupled to said plurality of light emitting diodes.

17. The method as recited in claim 13 wherein said controller further comprises a thumb wheel input device.

18. The method as recited in claim 17 wherein said input device is configured to select discrete numerals.

19. The method as recited in claim 13 wherein said cardinal numerals comprise digits from zero through nine.

20. The method as recited in claim 13 wherein said cardinal numerals comprise Hindu-Arabic digits from zero through nine.

21. The method as recited in claim 13 wherein said numeric display is a price display sign.

22. The method as recited in claim 13 wherein said third variable subset of said plurality of light emitting diodes is continuously illuminated.

23. The method as recited in claim 13 wherein a level of brightness of said plurality of light emitting diodes is adjustable for changing ambient light.

24. The method as recited in claim 23 wherein said level of brightness of said plurality of light emitting diodes is automatically adjusted for changing ambient light.

25. A numeric display sign, comprising:
a plurality of numeric displays, each of said plurality comprising:
a first matrix having nominally m columns by n rows;
a first plurality of light emitting diodes populating at least some of said first matrix;
first and second void areas within said first matrix wherein respective first and second subsets of said m columns by said n rows are devoid of said plurality of light emitting diodes;
a controller coupled to said plurality of light emitting diodes and configured to select a one of a plurality of fonts, said controller further configured to energize a third variable subset of said m columns by said n rows for at least one of a set of cardinal numerals, said third variable subset chosen from said one of said plurality of fonts.

26. The numeric display sign as recited in claim 25 further comprising a decimal point matrix having a second plurality of light emitting diodes populating said decimal point matrix.

27. The numeric display sign as recited in claim 25 further comprising a tenths matrix having a third plurality of light emitting diodes populating at least some of said tenths matrix.

28. A method of using a numerical display sign, comprising:
providing a matrix having nominally m columns by n rows;
populating at least some of said matrix with a plurality of light emitting diodes;
forming first and second void areas within said matrix wherein respective first and second subsets of said m columns by said n rows are devoid of said plurality of light emitting diodes; and
coupling a controller to said plurality of light emitting diodes and configuring said controller to store a plurality of fonts, and
selecting a one of said plurality of fonts; and
energizing a third variable subset of said m columns by said n rows for at least one of a set of cardinal numerals using said one of said plurality of fonts.
